(19) United States
(12) Patent Application Publication
(10) Pub. No.: US 2012/0213918 A1
(43) Pub. Date: Aug. 23, 2012

(54) VERTICALLY ALIGNING A CARBON NANOTUBES ARRAY

(75) Inventors: Kyong Hwa Song, Seoul (KR); Chi Hoon Choi, Gyeonggi-do (KR)

(73) Assignee: HYUNDAI MOTOR COMPANY, Seoul (KR)

(21) Appl. No.: 13/090,930

(22) Filed: Apr. 20, 2011

(30) Foreign Application Priority Data
Feb. 17, 2011 (KR) 10-2011-0014153

(51) Int. Cl. B05D 5/12; B82Y 40/00

(52) U.S. Cl. 427/113; 977/842

(57) ABSTRACT

The present invention provides a technique for vertically aligning a carbon nanotube array, which can improve vertical alignment at the bottom of the carbon nanotube array during growth of carbon nanotubes on a substrate. For this purpose, the present invention provides a method of vertically aligning a carbon nanotube array, the including: allowing carbon nanotubes to be grown on a substrate fed to a reactor and synthesized into a carbon nanotube array; and reducing the internal pressure of the reactor after (e.g., immediately after) synthesis of the carbon nanotube array to remove (e.g., instantly remove) a carbon source gas remaining in the reactor, thereby improving vertical alignment at the bottom of the carbon nanotube array.

### CROSS-REFERENCE TO RELATED APPLICATION

This application claims under 35 U.S.C. §119(a) the benefit of Korean Patent Application No. 10-2011-0014153 filed Feb. 17, 2011, the entire contents of which are incorporated herein by reference.

### BACKGROUND

(a) Technical Field

The present invention relates to vertically aligning a carbon nanotube array. More particularly, it relates to improving vertical alignment at the bottom of a carbon nanotube array during the growth of carbon nanotubes on a substrate.

(b) Background Art

Carbon nanotubes have recently been used in various applications due to their excellent electrical, mechanical, and thermal properties. However, precise control of the carbon nanotubes in terms of the thickness and length has not been easy. Carbon nanotubes with precisely controlled size and length can be applied to nano-devices such as field emitter tip, nanotweezer, atomic force microscopy (AFM) tip, etc.

For this reason, extensive research has been focused on the array of the carbon nanotubes. For example, U.S. Patent Application Publication Nos. 2008/0290326 and 2009/0297428 disclose methods of aligning carbon nanotubes using catalysts, and U.S. Patent Application Publication No. 2008/0075954 discloses a method for growing nanotubes with uniform length.

Recent research aimed at increasing the industrial applicability of carbon nanotubes is to fabricate a carbon nanotube yarn. The carbon nanotube yarn is fabricated by twisting a number of continuous fiber strands. Since the properties of carbon nanotubes can be used in the macroscopic world, the carbon nanotubes have attracted much attention. In this case, the carbon nanotubes are required to be vertically aligned and grown on a substrate. The carbon nanotubes vertically aligned and grown on the substrate are called a carbon nanotube array or carbon nanotube forest, which is generally synthesized by chemical vapor deposition.

The carbon nanotube yarn can be drawn directly from the carbon nanotube array and, at this time, the carbon nanotube yarn can be fabricated only from a highly vertically aligned carbon nanotube array.

Therefore, it is very important to improve the vertical alignment of the carbon nanotube array in the manufacturing of the carbon nanotube (CNT) yarn.

In other words, to fabricate the carbon nanotube yarn, it is important to improve the vertical alignment during synthesis of the carbon nanotube array and, especially, the vertical alignment at the bottom of the carbon nanotube array is very important.

According to existing methods, when a highly vertically aligned carbon nanotube array is grown on a substrate by chemical vapor deposition, the overall vertical alignment of the carbon nanotube array can be improved by changing test variables. However, the vertical alignment at the bottom of the carbon nanotube array is generally not good.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a technique for vertically aligning a carbon nanotube array, e.g., for fabrication of a carbon nanotube yarn, which can improve vertical alignment at the bottom of a carbon nanotube array by removing a carbon source gas from a reactor after synthesis of the carbon nanotube array on a substrate by chemical vapor deposition (e.g., instantly removing the carbon source gas from the reactor immediately after synthesis of the carbon nanotube array).

In one aspect, the present invention provides a method of vertically aligning a carbon nanotube array, the method comprising: allowing carbon nanotubes to be grown on a substrate fed to a reactor and synthesized into a carbon nanotube array; and reducing the internal pressure of the reactor after synthesis of the carbon nanotube array to remove a carbon source gas remaining in the reactor, thereby improving vertical alignment at the bottom of the carbon nanotube array.

In one embodiment, the method further comprises supplying an excessive amount of inert gas and hydrogen gas to the reactor after the cutting off of the supply of carbon source gas.

In another embodiment, the internal pressure of the reactor is reduced to a vacuum state.

In still another embodiment, the internal pressure of the reactor is reduced after the supply of carbon source gas is cut off.

The above and other features of the invention are discussed herein.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a flow diagram showing a method of vertically aligning a carbon nanotube array in accordance with an example embodiment of the present invention;

FIG. 2 is a scanning electron microscope (SEM) image showing the bottom of a carbon nanotube array synthesized in an Example of the present invention; and

FIG. 3 is an SEM image showing the bottom of a carbon nanotube array synthesized in a Comparative Example.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention provides a technique for vertically aligning a carbon nanotube array, in which the growth reaction of carbon nanotubes is terminated after synthesis of a carbon nanotube array to prevent the growth of carbon nanotubes with reduced vertical alignment at the bottom, thereby improving the vertical alignment at the bottom of the carbon nanotube array. Illustratively, in a preferred embodiment, the growth reaction of carbon nanotubes is instantly terminated immediately after synthesis of the carbon nanotube array.

According to the present invention, during synthesis of the carbon nanotube array by chemical vapor deposition, the internal pressure of the reactor is reduced to remove (e.g., instantly remove) the carbon source gas remaining in the reactor (for the growth reaction of carbon nanotubes) just before cutting off the supply of carbon source gas to the reactor.

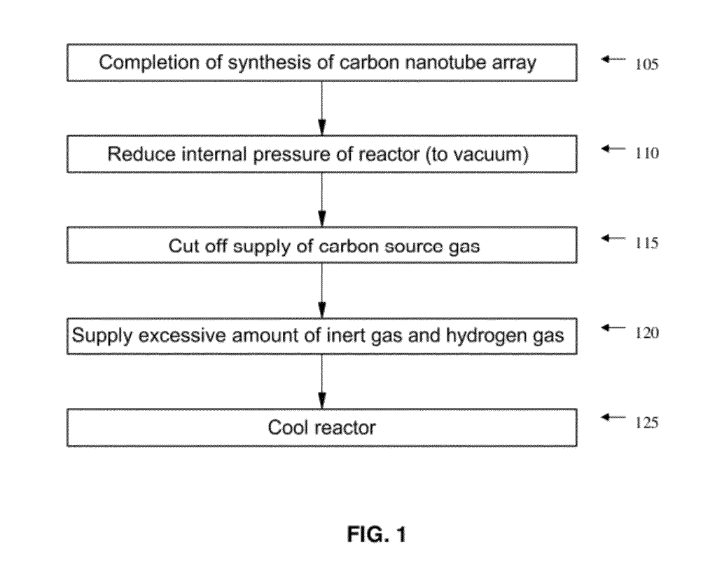

In detail, an illustrative method of vertically aligning the carbon nanotube array according to the present invention is shown in FIG. 1. In particular, and as described in greater detail below, the method illustratively comprises completing synthesis of a carbon nanotube array in step 105, and reducing the internal pressure of a reactor (e.g., to a vacuum) in step 110 just before the supply of carbon source gas to the reactor is cut off in step 115. In addition, in certain embodiments, the illustrative method further comprises supplying an excessive amount of inert gas and hydrogen gas to the reactor in step 120 and cooling the reactor in step 125. The techniques according to the present invention are now discussed in detail hereinafter.

For synthesis of the carbon nanotube array, a substrate for growing carbon nanotubes is first prepared, and the substrate is fed to the reactor.

After the carbon nanotubes are grown on the substrate for a desired period of time, the supply of carbon source gas is cut off to terminate the growth reaction. At this time, the internal pressure of the reaction is reduced just before the supply of carbon source gas is cut off, thereby removing the carbon source gas remaining in the reactor. Illustratively, the removal of the carbon source gas remaining in the reactor is instantaneous.

After the supply of carbon source gas is cut off, an excessive amount of inert gas and hydrogen gas can be supplied to the reactor to further remove the carbon source gas from the reactor (e.g., instantly). The term “excessive” in this sense implies that more inert gas and hydrogen gas than necessary during a typical reaction may be supplied to the reactor. In addition, in certain embodiments, the supply of heat to the reactor is also stopped to cool the reactor.

As a result, the synthesis of the carbon nanotube array is stopped (e.g., immediately or substantially immediately), and thus it is possible to obtain a carbon nanotube array with improved vertical alignment at the bottom.

Meanwhile, the internal pressure of the reactor may be reduced immediately after the supply of carbon source gas is cut off. In one or more illustrative embodiments, it is preferred that the internal pressure be reduced to a vacuum state to more rapidly remove the carbon source gas.

That is, the internal pressure of the reactor may be reduced after the supply of carbon source gas to the reactor is cut off (e.g., immediately after), and an excessive amount of inert gas and hydrogen gas is supplied to the reactor, thereby removing the carbon source gas from the reactor (e.g., instantly).

Moreover, as the carbon source gas, any gas such as acetylene, ethylene, methane, etc., which are generally used in the synthesis of the carbon nanotubes, may be used. As the inert gas, any of the elements in Group 18 such as argon, helium, nitrogen, etc. may be used. Moreover, the substrate may be formed of a semiconductor, nonconductor, or metal.

As such, according to the present invention, the growth of the carbon nanotube is stopped after the synthesis of the carbon nanotube array by removing the carbon source gas for the growth of the carbon nanotubes, and thus it is possible to prevent the growth of carbon nanotubes with reduced vertical alignment at the bottom, thereby obtaining a carbon nanotube array with excellent vertical alignment, which is entirely uniform.

In addition, the present invention can improve the vertical alignment at the bottom of the carbon nanotube array by reducing the internal pressure of the reaction to remove the carbon source gas from the reactor when the synthesis of the carbon nanotube array is completed.

Next, the present invention will be described in more detail with reference to an Example and a Comparative Example.

### Example

After an alumina thin film having a thickness of 10 nm was deposited on a silicon wafer (oriented in the <100> direction) by atomic layer deposition (ALD), an iron (Fe) thin film having a thickness of 1 nm was deposited on the alumina thin film by e-beam evaporation.

The thus prepared substrate was cut into a size of 1×1 cm and then put into a plasma-enhanced chemical deposition (PECVD) chamber.

The substrate was heated to 740° C. for 3 minutes while supplying argon gas at 500 sccm to the chamber. Then, argon gas was supplied at 2,800 sccm and hydrogen gas was supplied at 600 sccm to the chamber, and an RF power of 800 W and a bias of 300 W were applied to generate plasma in the chamber. These conditions were maintained for 10 seconds, and then acetylene gas was supplied at 50 sccm such that the growth reaction of carbon nanotubes was performed at 20 Torr.

After the growth reaction of carbon nanotubes was performed for 15 minutes, the internal pressure of the chamber was reduced and the supply of acetylene gas was immediately cut off. Then, hydrogen gas was supplied at 3,000 sccm and argon gas was supplied at 3,000 sccm to the chamber.

After 10 seconds, the supply of heat to the chamber was cut off by turning off a heater such that the chamber was cooled. After 2 minutes, the plasma was removed from the chamber. The internal pressure was returned to the atmospheric pressure when the temperature of the chamber (i.e., reactor) was reduced below 200° C., and then the substrate on which the carbon nanotubes were grown was taken out of the chamber.

### Comparative Example

The growth reaction of carbon nanotubes was performed in the same manner as the Example.

However, after the growth reaction of carbon nanotubes was performed for 15 minutes, the supply of acetylene gas and hydrogen gas was cut off, and argon gas was supplied at 500 sccm, respectively.

The plasma was removed from the chamber after turning off the heater. The internal pressure was returned to the atmospheric pressure when the temperature of the reactor was reduced below 200° C., and then the substrate on which the carbon nanotubes were grown was taken out of the chamber.

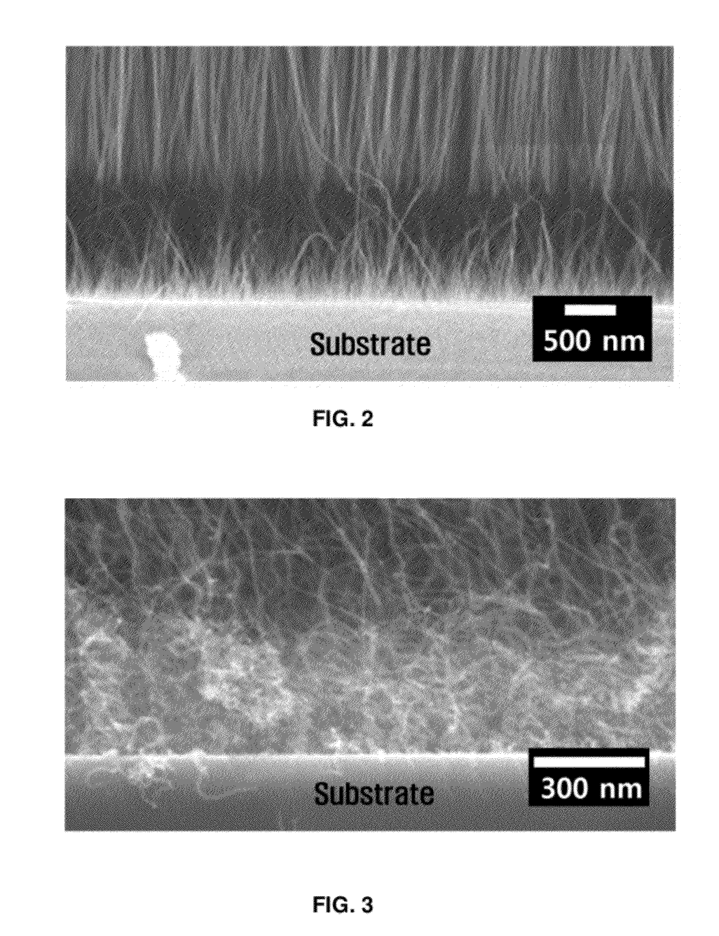

FIGS. 2 and 3 are scanning electron microscope (SEM) images showing the bottom of the carbon nanotube array synthesized in the Example and the Comparative Example, respectively.

As shown in FIG. 2, it can be seen that the carbon nanotube array obtained in the Example has excellent vertical alignment at the bottom. However, as shown in FIG. 3, the carbon nanotube array obtained in the Comparative Example, in which the growth reaction of the carbon nanotubes was terminated without reducing the internal pressure of the reactor, has significantly reduced vertical alignment at the bottom.

As described above, according to the present invention, the growth reaction of carbon nanotubes is terminated after the synthesis of the carbon nanotube array to prevent the growth of carbon nanotubes with reduced vertical alignment at the bottom, thereby improving the vertical alignment at the bottom of the carbon nanotube array. Illustratively, in a preferred embodiment, the growth reaction of carbon nanotubes is instantly terminated immediately after the synthesis of the carbon nanotube array.

Moreover, it is possible to fabricate a carbon nanotube yarn with high industrial applicability using the carbon nanotube array with improved vertical alignment according to the present invention.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents. For example, the invention may be embodied as a tangible, non-transitory computer-readable media comprising software, in which the software when executed by a processor is operable to perform one or more aspects of the techniques described above.

What is claimed is:

1. A method of vertically aligning a carbon nanotube array, the method comprising:
allowing carbon nanotubes to be grown on a substrate fed to a reactor and synthesized into a carbon nanotube array; and
reducing internal pressure of the reactor after synthesis of the carbon nanotube array to remove a carbon source gas remaining in the reactor.

2. The method of claim 1, wherein the internal pressure of the reactor is reduced immediately after synthesis of the carbon nanotube array to instantly remove the carbon source gas remaining in the reactor.

3. The method of claim 1, further comprising: supplying an excessive amount of inert gas and hydrogen gas to the reactor after cutting off a supply of carbon source gas.

4. The method of claim 1, wherein the internal pressure of the reactor is reduced to a vacuum state.

5. The method of claim 1, wherein the internal pressure of the reactor is reduced immediately after the supply of carbon source gas is cut off.

6. The method of claim 1, further comprising: cooling the reactor after synthesis of the carbon nanotube array.

7. A method, comprising:
growing carbon nanotubes on a substrate fed to a reactor;
synthesizing the carbon nanotubes into a carbon nanotube array; and
removing a carbon source gas remaining in the reactor after synthesis of the carbon nanotube array.

8. The method of claim 7, wherein removing the carbon source gas remaining in the reactor comprises reducing internal pressure of the reactor.

9. The method of claim 8, wherein the internal pressure of the reactor is reduced to a vacuum state.

10. The method of claim 7, wherein the carbon source gas remaining in the reactor is removed immediately after synthesis of the carbon nanotube array.

11. The method of claim 7, further comprising: supplying an excessive amount of inert gas and hydrogen gas to the reactor after cutting off a the supply of carbon source gas.

12. The method of claim 7, wherein the carbon source gas remaining in the reactor is removed immediately after a supply of carbon source gas is cut off.

13. The method of claim 7, further comprising: fabricating a carbon nanotube yarn using the carbon nanotube array.

14. The method of claim 7, further comprising:
placing the substrate into the reactor;
heating the substrate while supplying argon gas to the reactor;
supplying a first amount of inert gas and a second amount of hydrogen gas to the reactor;
applying an RF power to the gases to generate plasma in the reactor;
supplying the carbon source gas to the reactor to induce a growth reaction of carbon nanotubes into the carbon nanotube array;
after the growth reaction of carbon nanotubes and synthesis of the carbon nanotube array: i) reducing the internal pressure of the chamber and ii) cutting off the supply of carbon source gas.

15. The method of claim 14, further comprising: supplying a third amount of inert gas and a fourth amount of hydrogen gas to the reactor after cutting off the supply of carbon source gas.

16. A tangible, non-transitory computer-readable media comprising software for use with vertically aligning a carbon nanotube array, wherein the software when executed by a processor is operable to:
allow carbon nanotubes to be grown on a substrate fed to a reactor and synthesized into a carbon nanotube array; and
reduce internal pressure of the reactor substantially immediately after synthesis of the carbon nanotube array to substantially instantly remove a carbon source gas remaining in the reactor.
